(19) United States
(12) Patent Application Publication
(10) Pub. No.: US 2025/0299015 A1
(43) Pub. Date: Sep. 25, 2025

(54) ENTITY PERSONA GENERATED WITH QUANTUM KEYS

(71) Applicant: Bank of America Corporation, Charlotte, NC (US)

(72) Inventor: Manu Kurian, Dallas, TX (US)

(21) Appl. No.: 18/610,771

(22) Filed: Mar. 20, 2024

(51) Int. Cl. G06N 3/006; G06N 10/40

(52) U.S. Cl. CPC G06N 3/006; G06N 10/40

(57) ABSTRACT

Apparatus and methods for creating a persona to represent an entity are provided. The apparatus and methods may include a server with an artificial intelligence/machine learning (“AI/ML”) entity creation program that runs on a microprocessor and a quantum processor. The entity creation program may receive one or more traits of the entity's digital behavior on a network. The entity creation program may analyze the one or more traits and create a quantum key corresponding to each trait. The program may create a persona based on the quantum keys. A user may interact with the persona.

### FIELD OF TECHNOLOGY

Aspects of the disclosure relate to providing apparatus and methods for generating a persona for an entity with quantum computing.

### BACKGROUND OF THE DISCLOSURE

Artificial intelligence/machine learning (“AI/ML”) ‘personas’ are becoming more common. ‘Personas’ may be automatic, AI/ML-based, representations of users or entities in a networked space. They may be used separately or in concert with the user. The networked space may be the Internet, an internal intranet or other network, augmented reality, a metaverse, or other digital space.

Personas may be perceived as more capable avatars. In some embodiments, personas may interact with other users or other personas, with no input from the user, or even while the user is offline.

Properly created personas may be extremely powerful. Personas may be authorized to act on behalf of or bind a user to an agreement. The more powerful a persona is, the more responsibilities a persona has, the more accurate the persona should be.

As every online interaction may be unique, and there may be infinite varieties of interactions between a persona and a different user, accurate personas must be powerful and adaptable.

Personas may be linked to an entity as opposed to a particular person or user. An entity may be any company, government agency, or other structured entity. Personas representing an entity may be provided with various rules or factors to follow when interacting with a user.

Creating a viable and accurate persona for an entity may be difficult with current computing resources as the variety of online interactions and responses to interactions may be large in number or infinite. Hardcoding or anticipating every interaction and response may be impossible. Therefore, a persona created for an entity may be required to generate responses and other interactions without a previous specific example stored in a database.

Quantum computing, as opposed to standard computing, may provide more powerful computing resources required to create an accurate and powerful persona for an entity. Current methods of creating or generating a persona for an entity may not be powerful or accurate enough to create accurate personas.

Therefore, it would be desirable for apparatus and methods for generating a persona for an entity with quantum computing.

### SUMMARY OF THE DISCLOSURE

It is an object of this disclosure to provide apparatus and methods for generating a persona for an entity, specifically with quantum computing.

An apparatus for creating a persona for an entity is provided. The apparatus may include a central server.

The central server may include a server communication link, a server (standard) processor, an “N”-qubit processor, and a server non-transitory memory. “N” may be a number between 1 and 10,000.

The server non-transitory memory may be configured to store, at least, a server operating system and an AI/ML persona creation program executed on the server processor and the “N”-qubit processor.

The persona creation program may receive two or more traits of the entity's digital behavior on a network. The persona creation program may store the two or more traits in the non-transitory memory. The persona creation program may create two or more quantum keys on the “N”-qubit processor based on the two or more traits. The persona creation program may track the entity's digital behavior on the network for a pre-determined length of time to receive one or more additional traits of the entity's digital behavior. The persona creation program may store the one or more additional traits on the non-transitory memory. The persona creation program may update the two or more quantum keys with the one or more additional traits. The persona creation program may create the persona for the entity. The persona may include the two or more quantum keys.

In an embodiment, the network may be the Internet.

In an embodiment, the network may be an internal intranet.

In an embodiment, each quantum key may include one or more multi-possibility variables.

In an embodiment, each quantum key may be encrypted.

In an embodiment, the persona may be encrypted.

In an embodiment, the persona may include an audiovisual avatar.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative schematic in accordance with principles of the disclosure.

FIG. 4 shows an illustrative schematic in accordance with principles of the disclosure.

FIG. 5A shows an illustrative logic gate in accordance with principles of the disclosure.

FIG. 5B shows an illustrative logic gate in accordance with principles of the disclosure.

FIG. 6 shows an illustrative flowchart in accordance with principles of the disclosure.

FIG. 7 shows an illustrative apparatus in accordance with principles of the disclosure.

### DETAILED DESCRIPTION OF THE DISCLOSURE

It is an object of this disclosure to provide apparatus and methods to for creating an accurate and powerful persona for an entity with quantum computing.

In this disclosure, an entity may include a company, government, building, website, service, an application, an individual, and other entities.

An apparatus for creating a persona for an entity is provided. The apparatus may include a central server. In other embodiments, the server may be decentralized.

A persona may be an artificial intelligence/machine learning (“AI/ML”) representation of a person or entity. The persona may interact with users, such as customers, employees, agents, other personas, or others, in real-time. The persona may interact over a network. The persona may interact within a metaverse or other virtual reality world. The persona may interact with a user within an augmented-reality space. The persona may include an avatar representing the persona or entity.

Personas may be trained. Personas may be provided with a set of rules. Personas may adapt. Personas may anticipate a user's request(s). Personas may provide information, answer questions, provide services, or interact in other ways with users.

Personas may include one or more traits. The more traits included with a persona, the more accurate a representation of the entity the persona may be. Traits may include distinct answers or responses to various questions and situations. Traits may be dynamic. Traits may be trained. Traits may be derived from past historical data, provided rules or other information.

Quantum computing may be referred to as the use of quantum-mechanical phenomena such as superposition and entanglement to perform computations. The smallest bit in a quantum computer may be called a qubit.

The amount of data that a quantum computer may be able to hold and manipulate may grow exponentially with the number of qubits included in the quantum computer's processing core. A quantum computer with “N” qubits may be able to simultaneously represents 2ⁿ states. Therefore, two qubits may hold four states, three qubits may hold eight states, fifty qubits may hold 1, 125, 899, 906, 842, 624 states, and 10,000 qubits may hold 210000 states.

Quantum processors are associated with vastly improved efficiencies over classical computers. For example, whereas classical computers represent data in bits, which can be either 0 or 1, quantum processors use qubits which utilize superposition (i.e., the ability to be in multiple states at the same time until measured) to allow for a state of 0, 1, or any probability of being 0 or 1.

The probabilities can be manipulated using matrix-based quantum gates, which are analogous to classical logic gates. Qubits are therefore able to represent many more data possibilities than a bit-based system of the same size. This allows for greater speed and less memory usage than classical systems.

A qubit in a state of superposition may not have a defined value because it may hold many potential values at the same time. When measured, the qubit wave function collapses to a defined state. When an entangled qubit is in a state of superposition, each of its entangled connections is also in a state of superposition. These combinations of uncertainties may exponentially increase the power of quantum computers.

The quantum processor may include a default number of quantum threads. Each quantum thread may include a default number of quantum circuits. Quantum circuits, in turn, may refer to hardware and software based computational models that include quantum gates and are used for executing quantum computations.

For example, in some embodiments, at least one of the quantum circuits may include a Toffoli gate. A feature of the Toffoli gate is its universal nature, i.e., it is able to represent classical computer operations as well as quantum operations.

In certain embodiments, at least one of the quantum circuits may include a Hadamard gate. A feature of the Hadamard gate is the ability to represent a superposition state.

A quantum key, as used in this disclosure, may refer to a multi-possibility variable. A trait may be a multi-possibility variable. A trait may include one or more multi-possibility variables. For example, an entity may react to a question or statement from a user (or the same or similar question from a different user) with three different possible answers. Each answer may be more or less probable. The probability of each answer may depend on other factors. A quantum key may utilize all three answers with one qubit, due to the nature of qubits. Non-quantum computers would be required to factor in all three answers separately, unlike quantum computers.

Other standard components of a computer system may be present, such as communication links, displays, input and output devices, read-only and random-access memory, and other components.

The term “non-transitory memory,” as used in this disclosure, is a limitation of the medium itself, i.e., it is a tangible medium and not a signal, as opposed to a limitation on data storage types (e.g., RAM VS. ROM). “Non-transitory memory” may include both RAM and ROM, as well as other types of memory.

The non-transitory memory may be configured to store executable data configured to run on the “N”-qubit processor and/or a standard processor.

The “N”-qubit processor or standard microprocessors may control the operation of the computer system and its components, which may include RAM, ROM, an input/output module, and other memory. Standard microprocessors or standard processors may refer to non-qubit processors.

Other components commonly used for computers, such as EEPROM or Flash memory or any other suitable components, may also be part of the apparatus and computer system.

A communication link may enable communication with other computers and servers, as well as enable the program to communicate with databases. The communication link may include any necessary hardware (e.g., antennae) and software to control the link. Any appropriate communication link may be used, such as Wi-Fi, bluetooth, LAN, and cellular links. Multiple communication links may be present. In an embodiment, the network used to communicate may be the Internet. In another embodiment, the network may be an internal intranet or other internal network.

The program or server may receive data (such as traits or other data about an entity's digital behavior) from a database or elsewhere. Some or all of the data may be pre-processed. Some or all of the data may require processing. Some or all of the data may be digital data. Some or all of the data may require conversion to digital data. Some or all of the data may be in the form of, or include, rules. Some or all of the data may be processed to convert the data to digital data. Some or all of the data may be training data. Some or all of the data may be real-world data. Some or all of the data may include historical data. Some or all of the data may include real-time generated data. Some or all of the data may include multiple bytes of data.

The data may be received over a communication link. The data may be received from memory on the apparatus. The data may be transmitted automatically to the apparatus. The data may be transmitted by a system administrator or other user.

The central server may include a server communication link, a server (standard) processor, an “N”-qubit processor, and a server non-transitory memory. “N” may be a number between 1 and 10,000. Other standard components of a computer may be present. The more qubits present, the more powerful the server may be, and the more accurate the created persona may be.

In an embodiment, the server may be decentralized. A decentralized server may be more powerful than a centralized server, but may be less secure and more expensive.

The server non-transitory memory may be configured to store, at least, a server operating system and an AI/ML persona creation program executed on the server processor and the “N”-qubit processor. The server operating system may be configured to operate the server as well as other programs running on the server.

The persona creation program may utilize one or more artificial intelligence/machine learning (“AI/ML”) algorithms to perform one or more of its functions. Any suitable AI/ML algorithm may be used.

The persona creation program may include a user interface. The persona creation program may include one or more modules. Each module may be configured to perform one or more functions.

The program may receive two or more traits of the entity's digital behavior on a network. Traits may be expressed as variables. Traits may be expressed as digital data. Traits may be expressed as algorithms. Traits may be expressed as multi-possibility variables.

Traits may include one or more answers to the question: how did the entity react or respond to this particular situation? For example, if a user asked a representative of the entity, ‘how do I check my account balance?’ a trait may be or include the representative's response. Traits may include distinct answers or responses to various questions and situations. Traits may be dynamic. Traits may be trained. Traits may be derived from provided rules or other information. Traits may be rules, such as, “if a user requests x, answer with y or z, depending on factors ab, ac, and ad.” The more traits received by the program, the more accurate the persona may be.

In an embodiment, the program may derive traits through an analysis after receiving raw data on the entity's digital interactions with users. The raw data may be analyzed through one or more suitable AI/ML algorithms.

The persona creation program may store the two or more traits, or raw data, in the non-transitory memory. In an embodiment, the traits or raw data may be encrypted.

The persona creation program may create two or more quantum keys on the “N”-qubit processor based on the two or more traits. In an embodiment, one quantum key may be correlated with one trait. In alternative embodiments, one quantum key may include two or more traits. The program may use one or more AI/ML algorithms to translate trait(s) into quantum key(s).

The persona creation program may track the entity's digital behavior on the network for a pre-determined length of time to receive one or more additional traits of the entity's digital behavior. After receiving one or more traits, the program may require additional traits or behaviors to create a more accurate persona. One method of acquiring additional traits or behaviors may be to track the entity's digital behavior to determine how the entity (or its representative) responds to various situations on the network. The tracked digital behavior may be analyzed to determine if there are any new trait(s) in the digital behavior.

The pre-determined length of time may be for five minutes, a day, a week, etc. In an embodiment, the program may continuously monitor the entity's digital behavior and continuously update the persona based on the continuous monitoring.

The persona creation program may store the one or more additional traits on the non-transitory memory. Storing the data may allow for valid record-keeping, auditing of the data and persona, and provide a check on the validity of the persona for testing purposes.

The persona creation program may update the two or more quantum keys with the one or more additional traits. Updating the keys at pre-determined times, or continuously, may allow the persona to become more accurate over time. The process of updating the persona and the quantum keys may be iterative.

The persona creation program may create the persona for the entity. The persona may include the two or more quantum keys. The persona may be created through one or more AI/ML algorithms. The program may take into account the two or more quantum keys, the traits, and other information to create the persona. The more information (traits, keys, etc.) used to create the persona, the more accurate the persona may be. The persona may be adaptable (and not simply a script that provides set responses to set questions or situations).

In an embodiment, the network may be the Internet. It is anticipated that the persona and digital behavior will be most widely used on the Internet.

In an embodiment, the network may be an internal intranet. Digital behavior and information on an internal intranet may be quantitively and qualitatively different than behavior and information on a public network, such as the Internet.

In some embodiments, the persona may be used for training an employee of the entity. For example, the persona may be used to show the employee proper or improper responses to various situations.

In an embodiment, each quantum key may include one or more multi-possibility variables. A multi-possibility variable may be different than a standard variable in that multiple answers may be correct to the same algorithm. In an algorithm, once some variables are known, other variables may have only one possible correct answer. For example, if x+y=z, and z and y are known, x may have a definite answer (e.g., y=1 and z=3, x must be 2). However, if x were a multi-possibility variable, x may have multiple valid answers if y and z are known (e.g., y=1 orange and z=3 fruit, x can be any combination of two fruit, i.e., a function that results in 2 fruit).

A quantum key, as used in this disclosure, may refer to a multi-possibility variable. A trait may be a multi-possibility variable. A trait may include one or more multi-possibility variables. For example, an entity may react to a question from a user (or the same or similar question from a different user) with three different possible answers. Each answer may be more or less probable. The probability of each answer may depend on other factors. A quantum key may utilize all three answers with one qubit, due to the nature of qubits. Non-quantum computers would be required to factor in all three answers separately, unlike quantum computers.

In an embodiment, each quantum key may be encrypted. Any suitable encryption method or algorithm may be used.

In an embodiment, the persona may be encrypted. Any suitable encryption method or algorithm may be used.

In an embodiment, the persona may include a visual avatar. Including a visual avatar in the persona may allow the persona to be used in additional spaces, such as augmented reality, virtual reality, a metaverse, or other computer-generated space. Avatar-equipped personas may be more accurate and user-friendly than a simple text-generating persona. A persona may include audiovisual responses in addition to text responses.

An apparatus for creating a persona for an entity is provided. The apparatus may include a central server. The central server may include a server communication link, a server processor, an “N”-qubit processor, and a server non-transitory memory. The server non-transitory memory may be configured to store, at least, a server operating system and an AI/ML persona creation program executed on the server processor and the “N”-qubit processor. “N” may be a number between two and ten thousand.

The persona creation program may receive two or more traits of the entity's digital behavior on a network.

The persona creation program may store the two or more traits in the non-transitory memory.

The persona creation program may create two or more quantum keys on the “N”-qubit processor based on the two or more traits. One quantum key may be associated with one or more traits.

The persona creation program may track the entity's digital behavior on the network for a pre-determined length of time to receive one or more additional traits of the entity's digital behavior.

The persona creation program may store the one or more additional traits on the non-transitory memory.

The persona creation program may create an additional quantum key for each of the one or more additional traits.

The persona creation program may then create the persona for the entity. The persona may include the two or more quantum keys, the two or more traits, the one or more additional traits, and each additional quantum key, as well as any other programming necessary to create a functional and accurate persona.

In an embodiment, the persona may include generative AI/ML code, to generate responses to situations.

In an embodiment, the persona may include an avatar. The avatar may be a 2-dimensional or 3-dimensional representation of the persona. The avatar may be audiovisual-based. The avatar may include a voice. The avatar may be generated by the program.

In an embodiment, the program may generate an avatar for every interaction with a user. For example, one user may prefer to speak with someone with one accent, and another user may prefer to speak with someone with a different accent. The persona creation program may generate different avatars for different users.

In an embodiment, when a user interacts with the persona, the interaction may be transmitted to the central server.

In an embodiment, the interaction may be analyzed by the persona creation program.

In an embodiment, the persona creation program may update the persona based on the analysis.

In an embodiment, the persona creation program may update the persona in real-time based on the analysis.

In an embodiment, a user may initiate an interaction with the persona by transmitting a communication request to the entity.

In an embodiment, a user may interact with the persona by using an augmented reality/virtual reality (“AR/VR”) computing device. This computing device may be a headset, smartphone, tablet, smart glasses, or similar device.

A method for creating a persona for an entity is provided. The method may include the step of receiving, at an AI/ML persona creation program executed on a server comprising a microprocessor and an “N”-qubit quantum processor, two or more traits of the entity's digital behavior on a network.

The method may include the step of storing the two or more traits in non-transitory memory on the server.

The method may include the step of creating two or more quantum keys on the “N”-qubit processor based on the two or more traits. One quantum key may be associated with one or more traits.

The method may include the step of tracking the entity's digital behavior on the network for a pre-determined length of time to receive one or more additional traits of the entity's digital behavior.

The method may include the step of storing the one or more additional traits on the non-transitory memory.

The method may include the step of creating an additional quantum key for each of the one or more additional traits.

The method may include the step of creating the persona for the entity. The persona may include the two or more quantum keys, the two or more traits, the one or more additional traits, and each additional quantum key.

In an embodiment, the server may be centralized. In an embodiment, the server may be distributed, to utilize a larger pool of computing resources and provide redundancy. Centralized servers may be easier to secure but also provide a single failure point. Distributed servers may be more robust but may provide multiple avenues for malicious actors to target.

In an embodiment, the network may be the Internet. In another embodiment, the network may be an internal intranet. An internal intranet may be more limited than the Internet, but it may also be more secure. In an embodiment, the network may be encrypted.

In an embodiment, the method may include the step of training the persona at least on responses from a user interacting with the persona.

In an embodiment, the user may interact with the persona in a metaverse.

In an embodiment, the persona may appear as part of a user interface program, such as a chat interface.

In an embodiment, the user interface to interact with the persona may be accessed through a web browser.

In an embodiment, the user interface to interact with the persona may be streamed to a user device. A user device may be any computing device, and may include AR/VR devices.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

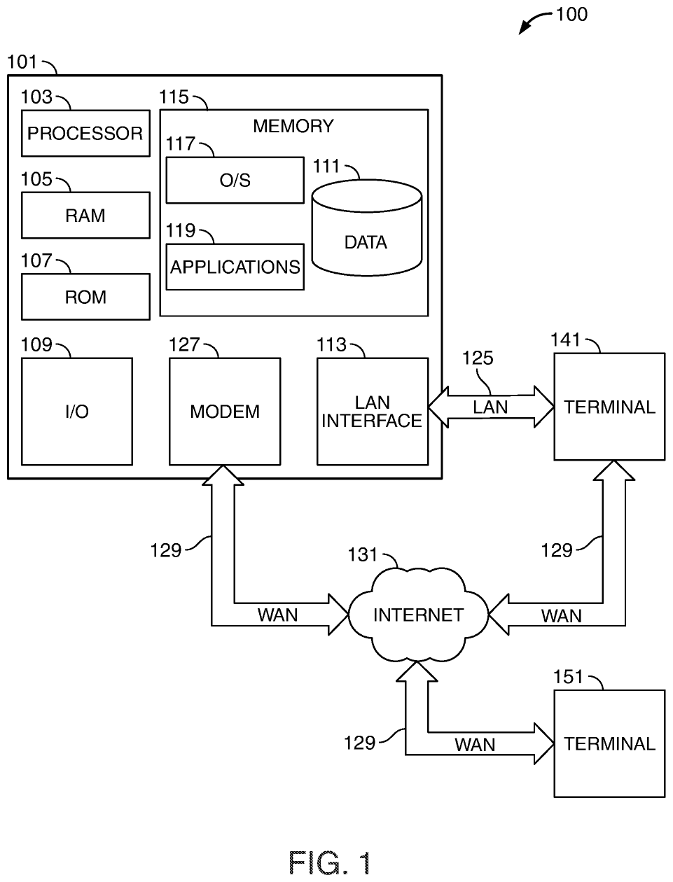

In accordance with principles of the disclosure, FIG. 1 shows an illustrative block diagram of apparatus 100 that includes a computer or computer system 101. Computer 101 may alternatively be referred to herein as a “computing device” or “computing system”. Computer 101 may be a quantum computer or part of a quantum computer. Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more “N”-qubit processors and standard microprocessors 103 for controlling the operation of the device and its associated components, and may include RAM 105, ROM 107, input/output module 109, and a memory 115. The processors 103 may also execute all software running on the computer 101—e.g., the operating system 117 and applications 119 such as an entity persona creation program and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as the entity persona creation program and an authentication engine) along with any other data 111 (e.g., traits and authentication information for users and entities) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

In an embodiment of the server 101, the processor 103 may execute the instructions in all or some of the operating system 117, any applications 119 in the memory 115, any other code necessary to perform the functions in this disclosure, and any other code embodied in hardware or firmware (not shown).

An input/output (“I/O”) module 109 may include connectivity to a keyboard, monitor, microphone, or network interface through which higher hierarchal server or a user of server 101 may provide input. The input may include input relating to cursor movement. The input/output module 109 may also include one or more speakers for providing audio output and a video display device, such as an LED screen and/or touchscreen, for providing textual, audio, audiovisual, and/or graphical output (not shown).

In an embodiment, apparatus 100 may consist of multiple servers 101, along with other devices.

Apparatus 100 may be connected to other systems, computers, servers, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, or servers that include many or all of the elements described above relative to apparatus 100. The network connections depicted in FIG. 1 include a local area network (LAN) 125 and a wide area network (WAN) 129 but may also include other networks. Server 101 may include a network interface controller (not shown), which may include a modem 127 and LAN interface or adapter 113, as well as other components and adapters (not shown).

When used in a LAN networking environment, server 101 is connected to LAN 125 through a LAN interface or adapter 113. When used in a WAN networking environment, server 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The server may transmit data to any other suitable computer system. The server may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for invoking user functionality related to performing various tasks. In an embodiment, application program(s) 119 may be cloud-based applications. In an embodiment, application program(s) 119 may be programs such as an entity persona creation program and/or security protocols. In an embodiment, the entity creation program may use one or more AI/ML algorithm(s). The various tasks may be related to creating a persona for an entity using quantum computing.

Server 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, smart mobile device, or any other suitable device for receiving, storing, transmitting and/or displaying relevant information. Terminal 151 and/or terminal 141 may be other devices such as remote servers. The terminals 151 and/or 141 may be computers where the user is interacting with the application that is being monitored by apparatus 100.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, server computers, hand-held or laptop devices, tablets, mobile phones, smart phones, smart mobile devices, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules maybe located in both local and remote computer storage media including memory storage devices.

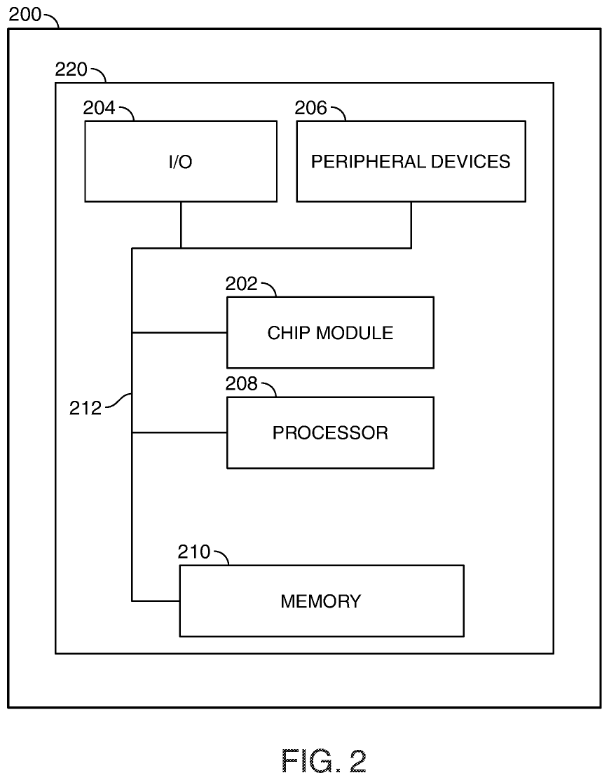

FIG. 2 shows illustrative apparatus 200 that may be configured in accordance with the principles of the disclosure. Apparatus 200 may be a quantum computer, a server, or computer with various peripheral devices 206. Apparatus 200 may include one or more features of the apparatus shown in FIGS. 1-6. Apparatus 200 may include chip module 202, which may include one or more quantum and integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, a display (LCD, LED, OLED, etc.), a touchscreen or any other suitable media or devices, peripheral devices 206, which may include other computers, logical processing device 208, which may be quantum based and may compute data information and structural parameters of various applications, and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based. The chip may be quantum-based.

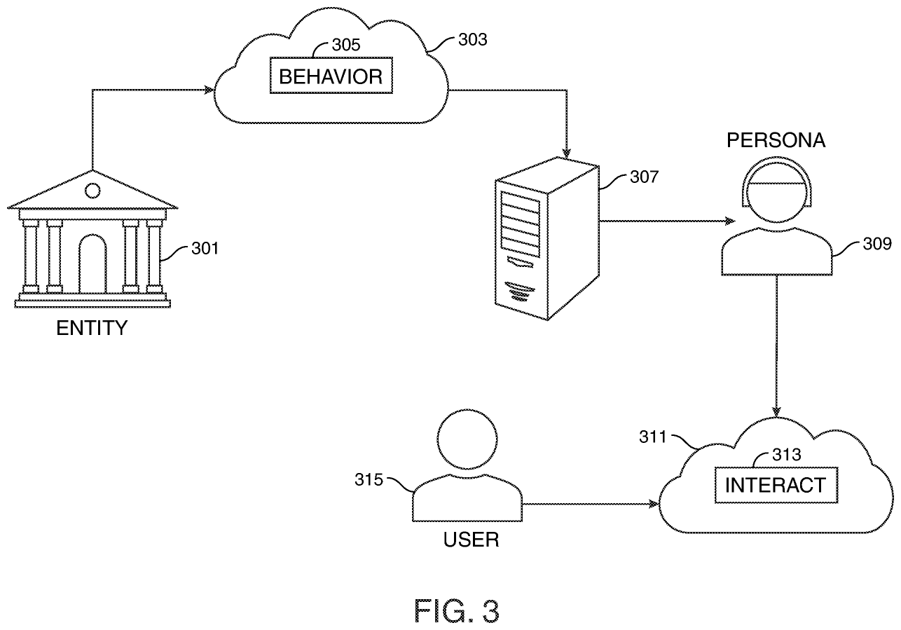

FIG. 3 shows an illustrative schematic in accordance with principles of the disclosure. An entity 301 may interact on a network 303. The entity 301's behavior 305 on the network 303 may be transmitted to or watched by a server 307.

Server 307 may include a standard processor and an “N”-qubit processor. An entity persona creation program on the server 307 may create a persona 309 for the entity 301.

The persona 309 may interact 313 on a network 311 (such as the Internet) with a user 315. The network 311 may be the same as or different than network 303.

Persona 309 may include quantum keys as well as other data. Persona 309 may include the behavior 305 of the entity 301 analyzed by the server 307.

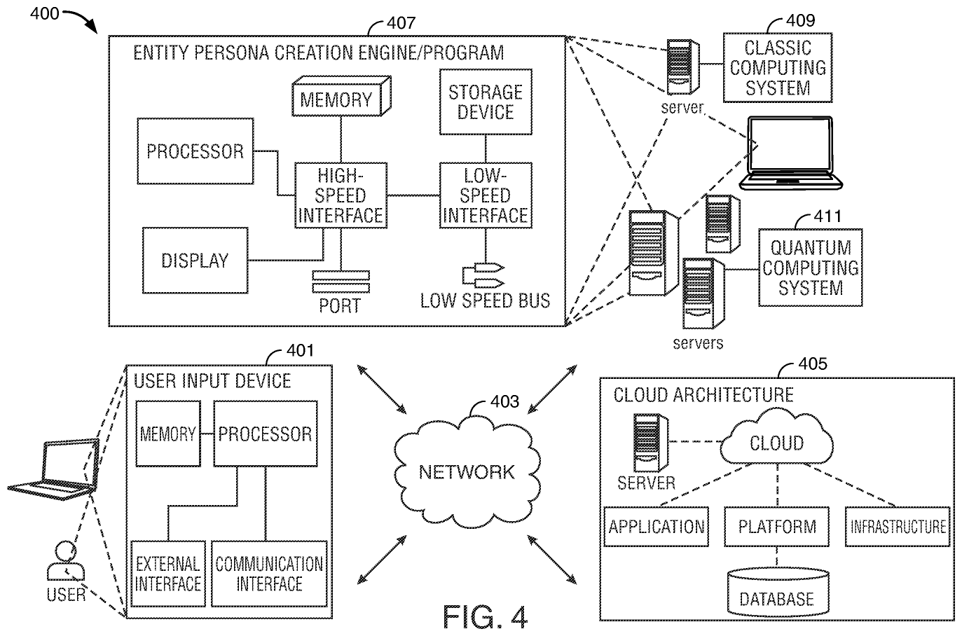

FIG. 4 shows illustrative diagram 400 in accordance with principles of the disclosure. Diagram 400 includes input device 401, cloud architecture 405, and entity persona creation engine/program 407, some or all of which may be in communication with each other via architecture network 403.

Input device 401 may include a memory, processor, external interface, and communication interface. Cloud architecture 405 may include various servers, applications, platforms, infrastructures, and databases. Entity persona creation engine/program engine 407 may include a quantum and standard processor, a display, memory, high- and low-speed interfaces, connection ports, and suitable memory devices and communication busses. The system may include a classic computing system 409 and a quantum computing system 411, which may analyze data and perform various computing tasks according to the methods and configurations disclosed herein.

The classic computing system 409 may include an AI/ML-based tool to manage the quantum computing system 411, according to the disclosure herein.

In an embodiment, the classic computing system 409 and quantum computing system 411 may be combined into one overall computer system with both classic (standard) and quantum-based processors. The entity persona creation engine/program 407 may be located on the combined computer system/server.

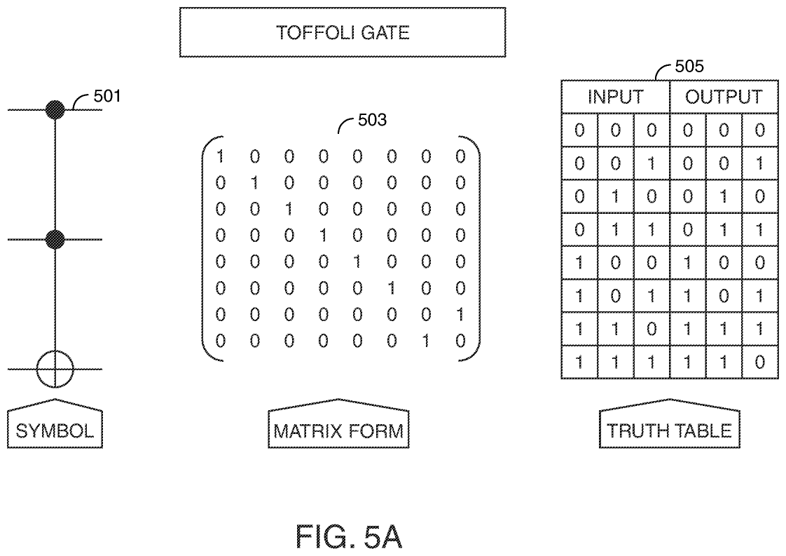

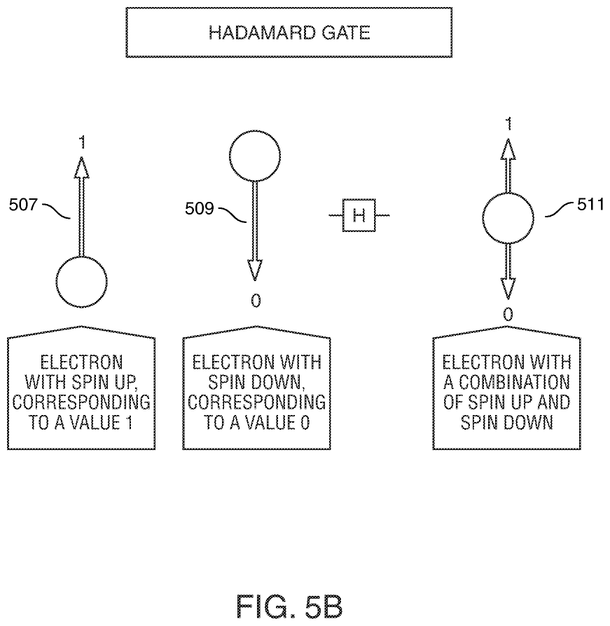

FIGS. 5A-5B show illustrative diagrams of exemplary quantum gates in accordance with principles of the disclosure. FIG. 5A shows symbol 501, matrix form 503, and truth table 505 of a Toffoli gate. A Toffoli gate is a universal reversible logic gate, which means that it enables simulation of any classical reversible circuit. In operation, as seen in truth table 505, the exemplary Toffoli gate has a 3-bit input and a 3-bit output. The first two output bits always mirror the first two input bits. The third bit also stays the same unless the first two input bits are both set to 1-in which case the third output bit is inverted from the third input bit. The Toffoli gate is therefore also known as the “controlled-controlled-not” gate.

FIG. 5B shows representations of a Hadamard gate. Symbol 507 shows a representation of electron spin up, which corresponds to the value 1. Symbol 509 shows a representation of electron spin down, which corresponds to the value 0. Symbol 511 shows a representation of electron spin up and down, which corresponds to the value that represents a superposition of 1 and 0.

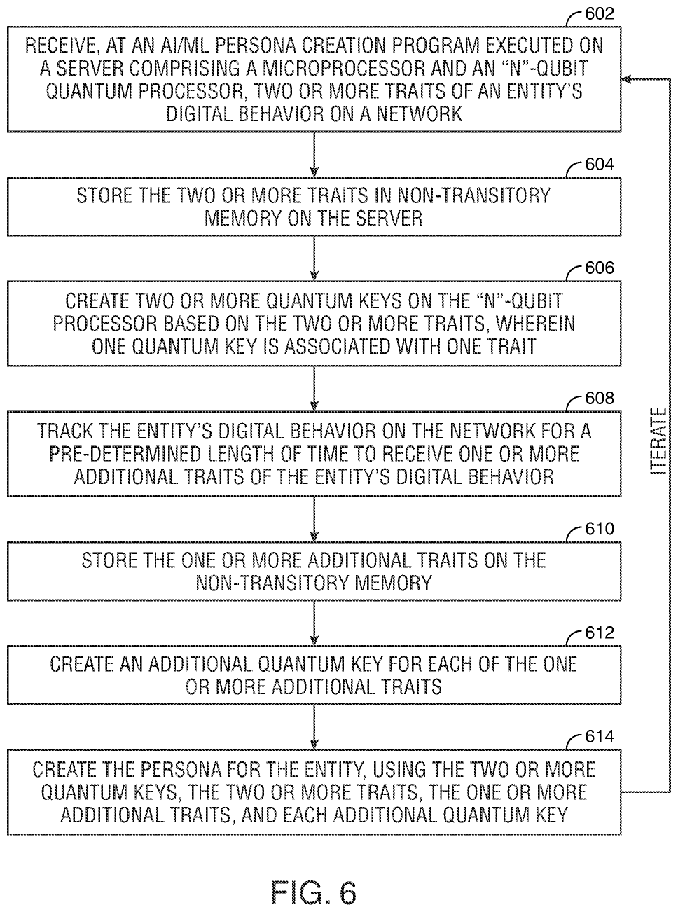

FIG. 6 shows an illustrative flowchart in accordance with principles of the disclosure. Methods may include some or all of the method steps numbered 602 through 614. Methods may include the steps illustrated in FIG. 6 in an order different from the illustrated order. The illustrative method shown in FIG. 6 may include one or more steps performed in other figures or described herein. Steps 602 through 614 may be performed on the apparatus shown in FIGS. 1-7, or other apparatus.

At step 602, an AI/ML entity persona creation program on a server that includes a standard processor and an “N”-qubit processor, may receive two or more traits of an entity's digital behavior on a network. The server may be centralized or distributed. The network may be the Internet, an internal intranet, or other network.

At step 604, the entity persona program may store the two or more traits in non-transitory memory on the server.

At step 606, the entity persona creation program may create two or more quantum keys on the “N”-qubit processor based on the two or more traits, or based on an analysis of the two or more traits. Each quantum key may be associated with one or more traits.

At step 608, the entity persona creation program may track the entity's digital behavior on the network for a pre-determined length of time. By tracking the behavior, the program may receive one or more additional traits of the entity's behavior.

At step 610, the entity persona creation program may store the one or more additional traits on the non-transitory memory.

At step 612, the entity persona creation program may create an additional quantum key for each of the one or more additional traits stored at step 610.

At step 614, the entity persona creation program may create the persona for the entity, using the two or more quantum keys, the two or more traits, the one or more additional traits, and each additional quantum key, as well as any other necessary data.

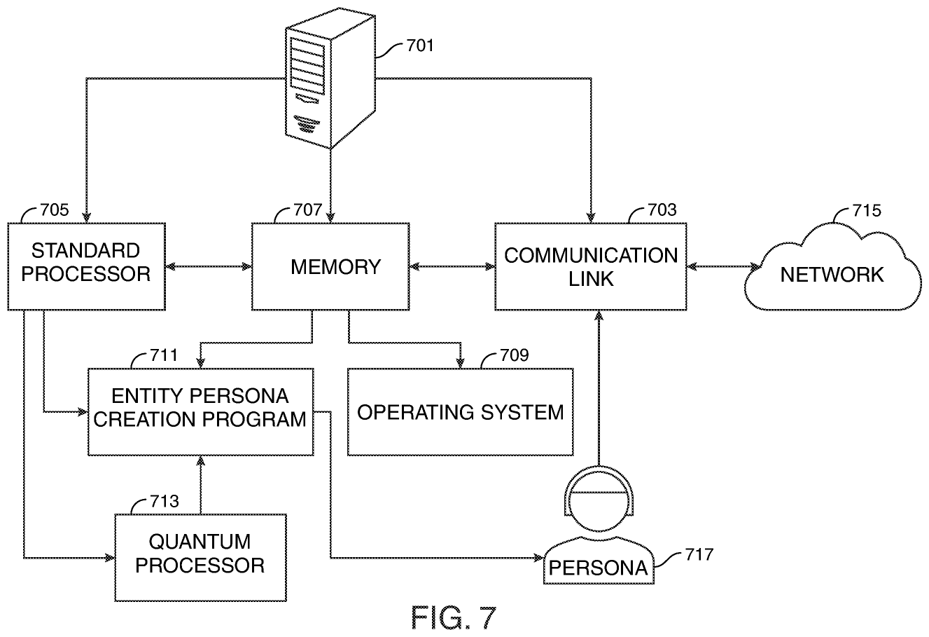

FIG. 7 shows an illustrative apparatus in accordance with principles of the disclosure. The apparatus may include a computer system 701 and a network 715. Computer system 701 may be a centralized or decentralized server.

Server 701 may include a server communications link 703, a standard processor/processors 705, a non-transitory memory 707, a “N”-qubit quantum processor 713, as well as other components, such as a graphical user interface.

The non-transitory memory 707, may include an operating system 709, as well as a copy of an entity persona creation application 711, as well as other data and programs.

The communications link 703 may communicate with other computer systems and databases over a network 715.

The entity persona creation application 711 may run on both the standard processor 705 and the quantum processor 713. In an embodiment, the application 711 may manage the quantum processor 713's activities through an AI/ML algorithm or algorithms run on the standard processor 705.

The entity persona creation application 711 may receive traits of the entity's digital behavior over the communication link 703.

The entity persona creation application 711 may create a persona 717 for the entity.

The persona 717 for the entity may communicate with a user or others on network 715 through communications link 703.

Thus, apparatus and methods for creating a persona for an entity using quantum computing are provided. Persons skilled in the art will appreciate that the present invention can be practiced by other than the described embodiments, which are presented for purposes of illustration rather than of limitation.

What is claimed is:

1. An apparatus to generate a persona for an entity, the apparatus comprising:
a central server, the central server comprising:
a server communication link;
a server processor;
an “N”-qubit processor; and
a server non-transitory memory configured to store at least:
a server operating system; and
an AI/ML persona creation program executed on the server processor and the “N”-qubit processor;
wherein the persona creation program:
receives two or more traits of the entity's digital behavior on a network;
stores the two or more traits in the non-transitory memory;
creates two or more quantum keys on the “N”-qubit processor based on the two or more traits;
tracks the entity's digital behavior on the network for a pre-determined length of time to receive one or more additional traits of the entity's digital behavior;
stores the one or more additional traits on the non-transitory memory;
updates the two or more quantum keys with the one or more additional traits; and
generates the persona for the entity, wherein the persona comprises the two or more quantum keys.

2. The apparatus of claim 1 wherein the network is the Internet.

3. The apparatus of claim 1 wherein the network is an internal intranet.

4. The apparatus of claim 1 wherein each quantum key comprises one or more multi-possibility variable.

5. The apparatus of claim 1 wherein each quantum key is encrypted.

6. The apparatus of claim 1 wherein the persona is encrypted.

7. The apparatus of claim 1 wherein the persona comprises a visual avatar.

8. An apparatus to create a persona for an entity, the apparatus comprising:
a central server, the central server comprising:
a server communication link;
a server processor;
an “N”-qubit processor; and
a server non-transitory memory configured to store at least:
a server operating system; and
an AI/ML persona creation program executed on the server processor and the “N”-qubit processor;
wherein the persona creation program:
receives two or more traits of the entity's digital behavior on a network;
stores the two or more traits in the non-transitory memory;
creates two or more quantum keys on the “N”-qubit processor based on the two or more traits, wherein one quantum key is associated with one trait;
tracks the entity's digital behavior on the network for a pre-determined length of time to receive one or more additional traits of the entity's digital behavior;
stores the one or more additional traits on the non-transitory memory;
creates an additional quantum key for each of the one or more additional traits; and
creates the persona for the entity, wherein the persona comprises:
the two or more quantum keys;
the two or more traits;
the one or more additional traits; and
each additional quantum key.

9. The apparatus of claim 8 wherein the persona comprises an avatar.

10. The apparatus of claim 8 wherein when a user interacts with the persona for the entity, the interaction is transmitted to the central server.

11. The apparatus of claim 10 wherein the interaction is analyzed by the persona creation program.

12. The apparatus of claim 11 wherein the persona creation program updates the persona based on the analysis.

13. The apparatus of claim 11 wherein the persona creation program updates the persona in real-time based on the analysis.

14. The apparatus of claim 8 wherein a user begins an interaction with the persona by transmitting a communication request to the entity.

15. The apparatus of claim 8 wherein a user interacts with the persona by using an augmented reality/virtual reality (“AR/VR”) computing device.

16. A method for creating a persona for an entity, the method comprising:
receiving, at an AI/ML persona creation program executed on a server comprising a microprocessor and an “N”-qubit quantum processor, two or more traits of the entity's digital behavior on a network;
storing the two or more traits in non-transitory memory on the server;
creating two or more quantum keys on the “N”-qubit processor based on the two or more traits, wherein one quantum key is associated with one trait;
tracking the entity's digital behavior on the network for a pre-determined length of time to receive one or more additional traits of the entity's digital behavior;
storing the one or more additional traits on the non-transitory memory;
creating an additional quantum key for each of the one or more additional traits; and
creating the persona for the entity;
wherein the persona comprises:
the two or more quantum keys;
the two or more traits;
the one or more additional traits; and
each additional quantum key.

17. The method of claim 16 wherein the server is centralized.

18. The method of claim 16 wherein the network is the Internet.

19. The method of claim 16 further comprising the step of training the persona at least on responses from a user interacting with the persona.

20. The method of claim 19 wherein the user interacts with the persona in a metaverse.
